(19) United States
(12) Patent Application Publication
(10) Pub. No.: US 2025/0103075 A1
(43) Pub. Date: Mar. 27, 2025

(54) SECOND VOLTAGE REGULATOR TO SUPPLY EXCESS CURRENT IN PARALLEL WITH FIRST VOLTAGE REGULATOR

(71) Applicant: Intel Corporation, Santa Clara, CA (US)

(72) Inventors: Khondker Ahmed, Hillsboro, OR (US); Nicolas Butzen, Portland, OR (US); Nachiket Desai, Portland, OR (US); Su Hwan Kim, Portland, OR (US); Harish K. Krishnamurthy, Beaverton, OR (US); Krishnan Ravichandran, Saratoga, CA (US); Kaladhar Radhakrishnan, Chandler, AZ (US); Jonathan Douglas, Cave Creek, AZ (US)

(21) Appl. No.: 18/474,156

(22) Filed: Sep. 25, 2023

(51) Int. Cl. G05F 1/56

(52) U.S. Cl. CPC G05F 1/56

(57) ABSTRACT

Embodiments herein relate to a stacked semiconductor structure which includes a first voltage regulator (VR), external to a package, for supplying current to a compute die in the package. When the required current exceeds a threshold, an additional current source is activated. The additional current source can include a second VR, also external to the package, for supplying current to an integrated voltage regulator (IVR) in the package. The IVR performs voltage down conversion and current multiplication to output a portion of the required current above the threshold, while the output of the first VR is capped at the threshold.

### FIELD

The present application generally relates to the field of voltage converters.

### BACKGROUND

Computing devices often rely on voltage converters, also referred to as voltage regulators, to obtain power. For example, direct current (DC)-to-DC voltage converters can convert a power supply at one DC voltage to another, typically lower DC voltage. A voltage converter can convert the main supply voltage of a computing device, such as 12-48 V, down to lower voltages, such as about 1 V. The lower voltages can be used by various components in the computing device, such as a Universal Serial Bus (USB) interface, memory such as dynamic random access memory (DRAM) and processing resources such as a central processing unit (CPU). However, it is challenging to supply power in an efficient and cost-effective manner.

### BRIEF DESCRIPTION OF THE DRAWINGS

The embodiments of the disclosure will be understood more fully from the detailed description given below and from the accompanying drawings of various embodiments of the disclosure, which, however, should not be taken to limit the disclosure to the specific embodiments, but are for explanation and understanding only.

FIG. 1A depicts a cross-sectional view of an example stacked structure 100 including a package base layer 110, a compute die 120, a first motherboard voltage regulator MBVR1, and a control circuit 140, in accordance with various embodiments.

FIG. 1B depicts a cross-sectional view of an example stacked structure 150 corresponding to the stacked structure of FIG. 1A with the addition of a base die 130 and a Static Random-Access Memory (SRAM) die 145 between the package base layer 110 and the compute die 120, in accordance with various embodiments.

FIG. 2 depicts a cross-sectional view of an example stacked structure 200 corresponding to the stacked structure of FIG. 1B with the addition of a second MBVR (MBVR2) 210 and a chiplet 220 comprising an integrated voltage regulator (IVR) 221, in accordance with various embodiments.

FIG. 3 depicts example plots of MBVR1 current and IVR current versus compute die current consumption in the stacked structure of FIG. 2, in accordance with various embodiments.

FIG. 4 depicts an example plot of efficiency versus compute die current consumption in the stacked structure of FIG. 2, in accordance with various embodiments.

FIG. 5 depicts example circuit blocks of the IVR 221 of FIG. 2, in accordance with various embodiments.

FIG. 6 depicts an example implementation of the IVR controller and power stage 530 of FIG. 5, including an IVR controller 600 and a power stage 650 comprising a switching inductor-based VR, in accordance with various embodiments.

FIG. 7 depicts example circuit blocks of the parallel IVR operation controller 510 of FIG. 5, in accordance with various embodiments.

FIG. 8 depicts example circuit blocks of the IVR efficiency optimizer 520 of FIG. 5, in accordance with various embodiments.

FIG. 9 depicts a cross-sectional view of an example stacked structure 900 corresponding to the stacked structure of FIG. 2 except that the IVR 221 is incorporated into the base die 130, in accordance with various embodiments.

FIG. 10 depicts a cross-sectional view of an example stacked structure 1000 corresponding to the stacked structure of FIG. 2 except that the IVR 221 is incorporated into the compute die 120, in accordance with various embodiments.

FIG. 11 depicts a cross-sectional view of an example stacked structure 1100 corresponding to the stacked structure of FIG. 10 except that the compute die is driven at 120% of Iccmax, in accordance with various embodiments.

FIG. 12A depicts an example power supply configuration in which MBVR1 provides current directly to a compute die, and optionally indirectly through an IVR, and MBVR2 provides current to the compute die through the IVR, in accordance with various embodiments.

FIG. 12B depicts an example power supply configuration in which MBVR1 provides current directly to a compute die, and optionally indirectly through any form of voltage down converter, and MBVR2 provides current to the compute die through the voltage down converter, in accordance with various embodiments.

FIG. 12C depicts an example power supply configuration in which MBVR1 provides current directly to a compute die, and MBVR2 provides current to the compute die through a buck VR, in accordance with various embodiments.

FIG. 12D depicts an example power supply configuration in which MBVR1 provides current directly to a compute die, and optionally indirectly through a buck VR, and MBVR2 is not used, in accordance with various embodiments.

FIG. 12E depicts an example power supply configuration in which MBVR1 provides current directly to a compute die, and optionally indirectly through a switched capacitor VR, and MBVR2 provides current to the compute die through the switched capacitor VR, in accordance with various embodiments.

FIG. 12F depicts an example power supply configuration in which MBVR1 provides current directly to a compute die, and optionally indirectly through a Continuously Scalable Conversion Ratio (CSCR) VR, and MBVR2 provides current to the compute die through the CSCR VR, in accordance with various embodiments.

FIG. 13 depicts example bar charts 1300 and 1350 showing first and second portions of a current consumption to be provided by MBVR1 and the IVR, in associated with the second VR, MBVR2, in accordance with various embodiments.

FIG. 14 depicts a switched-capacitor VR 1400 as an example implementation of an IVR, MBVR1 and/or MBVR2, in accordance with various embodiments.

FIG. 15 depicts a CSCR VR 1500 as an example implementation of an IVR, MBVR1 and/or MBVR2, in accordance with various embodiments.

FIG. 16 illustrates an example of components that may be present in a computing system 1650 for implementing the techniques (e.g., operations, processes, methods, and methodologies) described herein.

### DETAILED DESCRIPTION

Increasing performance demands in computing devices require higher power delivered to the computing silicon. To address these demands, 3D integration can be used in which chips are stacked vertically in a package. Signals and current can be transferred between the chips using conductive paths such as micro bumps. However, for a given silicon area, the number of bumps available to deliver the current, and the current each bump can carry, limit the total current (Iccmax) that can be supplied to the silicon.

One approach is to provide a motherboard voltage regulator (MBVR) external to the package. The MBVR can supply current to the package via a conductive path/trace in a package base layer. Power delivery solutions with MBVRs are generally efficient but, since the load current needs to traverse the motherboard tracks, the efficiency degrades as the current demands increase. Additionally, MBVRs are slower to respond to on-die load transients which can occur due to dynamic activities such as Dynamic Voltage Frequency Scaling (DVFS). DVFS is a power management technique in computer architecture in which the frequency of a microprocessor is adjusted based on its current needs to conserve power and reduce heat generation.

The solutions provided herein address the above and other disadvantages. The solutions address the need for efficient power delivery at increased current and with dynamic current requirements. In one aspect, the solutions address the problem of increased load current demand and efficiency degradation by introducing a second MBVR and an in-package Integrated Voltage Regulator (IVR) that can operate in parallel with a first MBVR to supply power to a load in the package such as a compute die. A compute die may contain a processor or other circuits which consume current. A compute die is an example of a load die. The second MBVR and the IVR can be activated (e.g., run, operated or provided in an on state) when the first MBVR current exceeds a certain threshold such as 70% of Iccmax. The first MBVR continues to be activated and run at this time. Upon activation, the IVR supplies the excess current while the first MBVR keeps supplying the fixed current amounting to the activation threshold value. By operating in parallel, this technique and its variants offer improved system efficiency and, in some cases, increased Iccmax capabilities.

The solutions provide a number of advantages. First, end-to-end efficiency of the computing system is improved. A reduced input power plane current results in reduced resistive path loss (equated by I²R) and improved efficiency. Second, the size of the first MBVR can be reduced. In particular, for an iso-load current, the first MBVR now needs to supply only a fraction of the Iccmax (70%, for example) and hence can now be reduced in size, resulting in cost savings in passive components used and board area savings. Third, response time is improved for current/voltage transient events since the in-package IVR can be designed to be faster than the external first MBVR and is now located closer to the compute die or other load. Hence, the parallel current path can now provide quicker mitigation from transient droop events due to voltage and current steps/variations. Fourth, thermal/heat transfer management is a challenge that can diminish system efficiency and power deliver density. Therefore, in a stacked die configuration, limiting the on-die power delivery to only excess current reduces the thermal bottleneck and challenges of the stacked die approach. Fifth, in many personal computing applications, the residency for high-current operations is low. A parallel IVR that supplies the excess current can be designed to improve the system efficiency without imposing a design burden on the first MBVR. Sixth, the parallel IVR-MBVR architecture provides adjustments for maximizing the system level efficiency, resulting in benefits including a prolonged battery life.

An example embodiment involves a stacked semiconductor structure which includes a first voltage regulator (VR) external to a package for supplying current to a compute die in the package. When the required current exceeds a threshold, an additional current source is activated. The additional current source can include a second VR external to the package for supplying current to an integrated voltage regulator (IVR) in the package. The IVR performs voltage down conversion and current multiplication to output a portion of the required current above the threshold, while the output of the first VR is capped at the threshold.

These and other features will be further apparent in view of the following discussion.

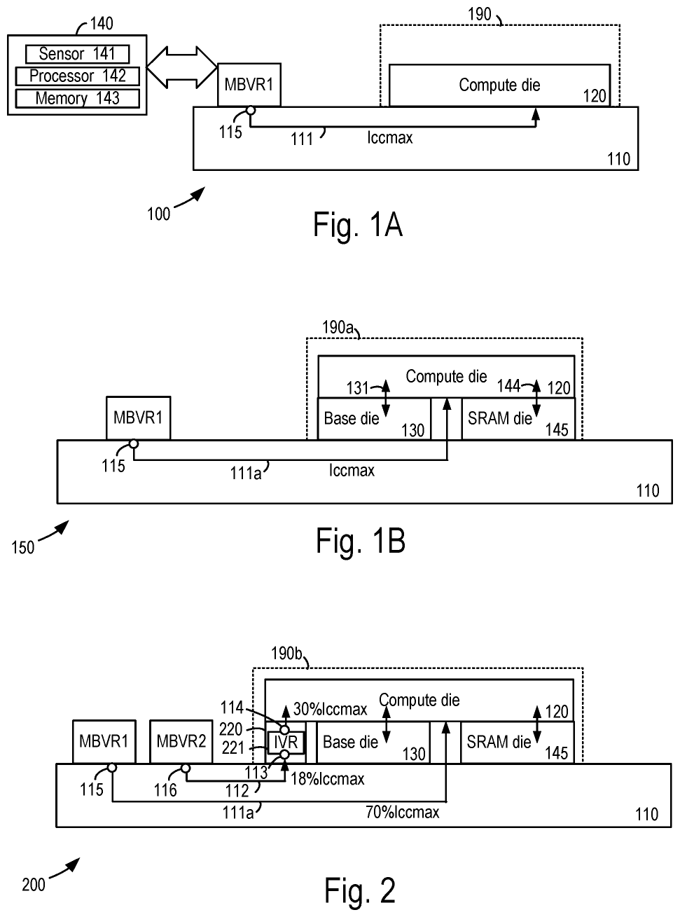

FIG. 1A depicts a cross-sectional view of an example stacked structure 100 including a package base layer 110, a compute die 120, a first motherboard voltage regulator MBVR1, and a control circuit 140, in accordance with various embodiments. The compute die can be a die which includes a processor or other circuit which consumes current supplied by MBVR1. MBVR1 is a first VR which supplies a current (e.g., Iccmax or other required current) to the compute die through an output node 115 and the package power plane, e.g., through a conductive path 111 in the package base layer/substrate. In one approach, the first VR is to provide the first current to the compute die/circuit without the first current undergoing current multiplication and/or voltage down conversion.

Iccmax is the maximum current which the compute die can draw when it is operating at 100% of its rated capacity and not being over clocked. The data sheet for a compute die or processor will typically specify this value. This is the maximum sustained current draw. In some cases, the compute die or other load can temporarily draw more than 100% of Iccmax, such as when a processor on the compute die is being over clocked.

MBVR1 may be on a motherboard or other printed circuit board in one approach which in turn is attached to the package base layer by micro bumps or other conductive points. The compute die may be in a package 190 with one or more other die. The compute die may have conductive points such as micro bumps for communicating with conductive paths in the package base layer including the conductive path 111. The package may be a semiconductor package including a metal, plastic, glass, or ceramic casing encapsulating/containing one or more discrete semiconductor devices or integrated circuits. The package base layer can be considered to be a high-density circuit board/substrate. The package base layer die may have conductive points such as micro bumps for communicating with an underlying printed circuit board to which it is attached.

A control circuit 140 may communicate with MBVR1 and the compute die. The control circuit includes a sensor 141, a processor 142 and a memory 143. The memory stores instructions to be executed by the processor. The sensor is capable of sensing an output voltage of MBVR1 and implementing a control loop to regulate the output voltage.

However, as mentioned, a limited bump count hinders the increase in compute die current demand. Additionally, there is a slow transient response due to the MBVR1 being external to the package 190.

FIG. 1B depicts a cross-sectional view of an example stacked structure 150 corresponding to the stacked structure of FIG. 1A with the addition of a base die 130 and a Static Random-Access Memory (SRAM) die 145 between the package base layer 110 and the compute die 120, in accordance with various embodiments. The base die can perform various overhead functions such as allowing the compute die to communicate with peripherals. The SRAM die can include memory resources for use by the compute die. The arrows 131 and 144 represent the communication of signals between the compute die and the base die or SRAM die, respectively. In the package 190a, the compute die can be stacked on the base die and the SRAM die and communicate with the two underlying die via micro bumps or other conductive paths.

MBVR1 provides its current to the compute die via a path 111a which extends up from the package base layer to the compute die, e.g., via an insulated space between the base die and the SRAM die. In another approach, the path extends upward through one of the die 130 or 145, e.g., in a through-silicon via.

Note that power delivery to the base die and SRAM die is not depicted here. The power consumption by these dies is relatively small compared to that of the compute die. In one approach, MBVR1 includes a portion or slice which also supplies power to these dies.

FIG. 2 depicts a cross-sectional view of an example stacked structure 200 corresponding to the stacked structure of FIG. 1B with the addition of a second MBVR (MBVR2) 210 and a chiplet 220 comprising an integrated voltage regulator (IVR) 221, in accordance with various embodiments. As with MBVR1, MBVR2 may be attached to the top of the package base layer. In one approach, MBVR2 is configured to output a second current via an output node 116 and a conductive path 112 in the package base layer when MBVR1 is outputting a first current. The second current can be less than the first current. The second current can be less than 50% of Iccmax and the first current can be more than 50% of Iccmax. In one approach, MBVR2 does not output current until the first current exceeds a threshold. An example threshold is 70% of Iccmax. The threshold can be greater than 50% of Iccmax, in one approach. Additionally, an IVR 221 is part of a chiplet 220 which is attached to the package base layer in a package 190b. The IVR receives the second current from MBVR2 at an input node 113 and is configured to provide voltage down conversion and the associated current multiplication at an output node 114, which is coupled to the compute die.

For example, assuming the compute die requires Iccmax. Then, the second current may be 18% of Iccmax, which is multiplied by the IVR to 30% of Iccmax, assuming a 2:1 current multiplication and an 83% efficiency. The compute die thus receives 100% of Iccmax, where 30% is provided by MBVR2 and the IVR and 70% is provided by MBVR1. Since the second current in the conductive path 112 is relatively small, the efficiency is relatively high.

The IVR and MBVR2 work in parallel with MBVR1 to supply the current needed by the compute die. In one approach, the IVR down converts the voltage by 2:1 and hence has a reduced input current. At Iccmax current delivery, the IVR supplies a fraction (e.g., 30%) of the load current, resulting a net decrease in the input current due to the 2:1 current transformation ratio. Factoring in an example 83% conversion efficiency, the combined input current through the package plane is now only 88% (70%+18%) as compared to the baseline 100%, reducing package plane resistive losses and improving end-to-end efficiency. MBVR2 and the parallel IVR can be activated in response to a comparison of the load current with a pre-defined or variable threshold.

MBVR2 can be controlled by the same control circuit 140 of MBVR1, in one approach, or have its own control circuit/controller.

Note that MBVR1 and MBVR2 refer to one possible implementation in which these VRs are on one or more mother boards. However, these VRs can be located external to the package in any way, and can generally be considered to be first and second VRs, respectively.

The IVR can include a control circuit which is similar to the control circuit 140 of FIG. 1A. In one approach, the control circuit adjusts the operation of the IVR, such as a duty cycle, to achieve a desired voltage down conversion. The control circuit may use a feedback control loop which compares the output voltage at the output node 114, or a version of the output voltage, to a reference voltage.

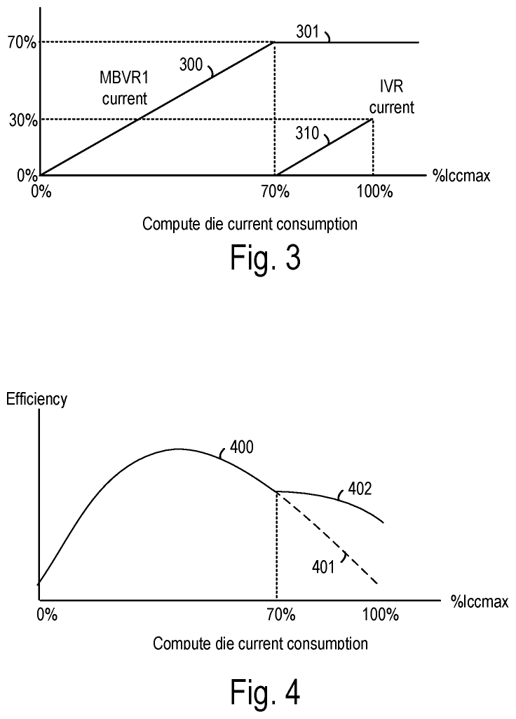

FIG. 3 depicts example plots of MBVR1 current and IVR current versus compute die current consumption in the stacked structure of FIG. 2, in accordance with various embodiments. The plots provide an example of an IVR activation threshold and the current distribution between MBVR1 and the IVR. The plot 300 depicts the MBVR1 current increasing in a 1:1 ratio with the current consumption, when the current consumption is less than a threshold such as 70% of Iccmax. The plot 301 depicts the MBVR1 current being capped at, e.g., limited to, the threshold when the current consumption exceeds the threshold. The plot 310 depicts the IVR current increasing in a 1:1 ratio with the current consumption, when the current consumption exceeds the threshold. The IVR current is an excess current, beyond 70% of Iccmax.

70% of Iccmax is an example activation threshold at which the IVR starts supplying current to the compute die in parallel with the first current from MBVR1. The IVR supplies current based on the current supplied to it by MBVR2, which is activated with the IVR, as these two VRs work together.

Below the threshold, MBVR1 supplies all of the current demanded by the compute die, in one approach. However, once the IVR is activated, the MBVR1 current is capped or maxed out at the threshold value (70% of Iccmax in this example) and continues to supply that fixed amount, e.g., within a tolerance of +/−5-10%. The additional current demanded is supplied by the IVR, up to 30% of Iccmax in this example. In tandem, these two VRs can still supply the total Iccmax, similar to the baseline example of FIGS. 1A and 1B. Since the IVR down converts the voltage, the input current it demands is decreased as well, resulting a net reduction of the input current flow through the package power plane in the conductive path 112 of FIG. 2. The reduction in input current reduces the resistive loss through the package power plane and improves the overall efficiency of the system as shown in FIG. 4.

FIG. 4 depicts an example plot of efficiency versus compute die current consumption in the stacked structure of FIG. 2, in accordance with various embodiments. The plot 400 represents the case of MBVR1 alone supplying the compute die current of up to 70% Iccmax. The plot 402 represents the case of MBVR1 supplying 70% of Iccmax and the IVR supplying the remaining current. The dashed line plot 401 represents the case of MBVR1 alone supplying the compute die current of 70-100% Iccmax. The difference between the plots 401 and 402 thus represents an efficiency improvement with the solutions provided herein.

The efficiency of MBVR1 peaks at about 45% of Iccmax in this example.

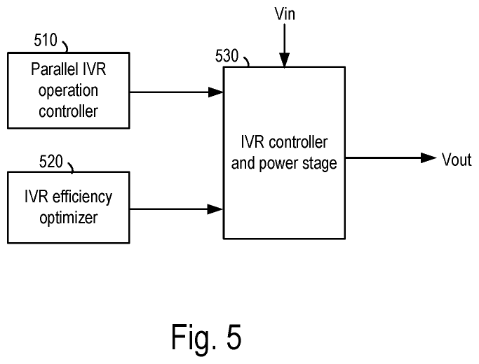

FIG. 5 depicts example circuit blocks of the IVR 221 of FIG. 2, in accordance with various embodiments. The IVR module can be enhanced by using different circuit blocks that enable the VR partitioning described herein. The example functional circuit modules can be inside the IVR system. They include an IVR controller and power stage 530 which receives an input voltage Vin as well as inputs from a parallel IVR operation controller 510 and an IVR efficiency optimizer 520. These circuit modules work in tandem with each other to determine when to turn on the parallel operation as well as tuning different parameters of the IVR to maximize operating efficiency at any load current.

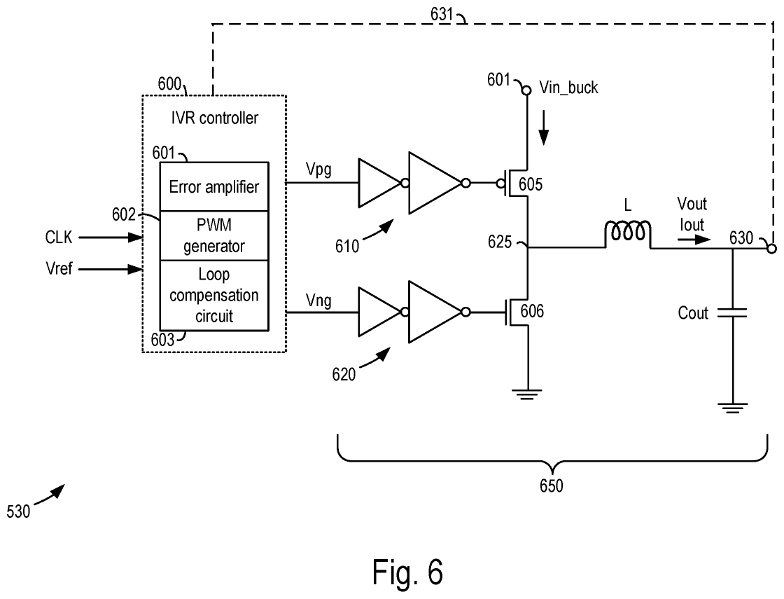

FIG. 6 depicts an example implementation of the IVR controller and power stage 530 of FIG. 5, including an IVR controller 600 and a power stage 650 comprising a switching inductor-based VR, in accordance with various embodiments. The switching inductor-based VR could also represent MBVR1 and/or and MBVR2.

The first VR controller includes an error amplifier 601, pulse-width modulation (PWM) generator 602 and a loop compensation circuit 603. The error amplifier and loop compensation circuit are part of a feedback control loop used to regulate Vout. The error amplifier receives Vout, or a version of Vout, via the feedback path 631, and compares it to a reference voltage Vref. The output of the amplifier is provided as an input to the PWM generator so that the duty cycle of the PWM's output signal can be adjusted. The PWM generator is also responsive to a clock signal CLK which controls the frequency of the PWM's output signal. The loop compensation circuit may also use Vout, or a version of Vout, to adjust the loop bandwidth and tailor the frequency response. The PWM generator outputs voltage signals Vpg and Vng to the control gates of the transistors 605 and 606 (power transistors), via inverter pairs 610 and 620, respectively, respectively.

The VR includes a p-type metal-oxide-semiconductor field-effect transistor (pMOSFET) 605 in series with an n-type MOSFET 606. The transistors 605 and 606 are also referred to as a high-side driver (or power switch or power FET) and a low-side driver, respectively. Inverter pairs 610 provide a delayed version of Vpg to the control gate of the transistor 605, and the inverter pairs 620 provide a delayed version of Vng to the control gate of the transistor 606. The voltage signals may alternate between high and low levels, where Vpg has a high level when Vng has a low level, and Vpg has a low level when Vng has a high level. When its voltage signal Vpg is low, the transistor 605 is conductive and allows charge from the input node 601, at a voltage Vin_buck, to reach a node 625 which is between, and in series with, the transistors. At this time, the transistor 606 is non-conductive so that the node is isolated from a ground path. An inductor L coupled to the node 625 is then charged up.

When the voltage signal Vng is high for the transistor 606, the transistor 606 is conductive and grounds the node 625. At this time, the transistor 605 is non-conductive to isolate the node 625 from the input node 601. The inductor L discharges to an output node 630 to provide a voltage Vout and a current Iout. An output or load capacitor Cout is coupled between the output node and ground to smooth the output voltage.

The VR is a buck converter in which the transistors are alternately turned on and off according to respective duty cycles and/or switching frequencies to maintain Vout at a desired level.

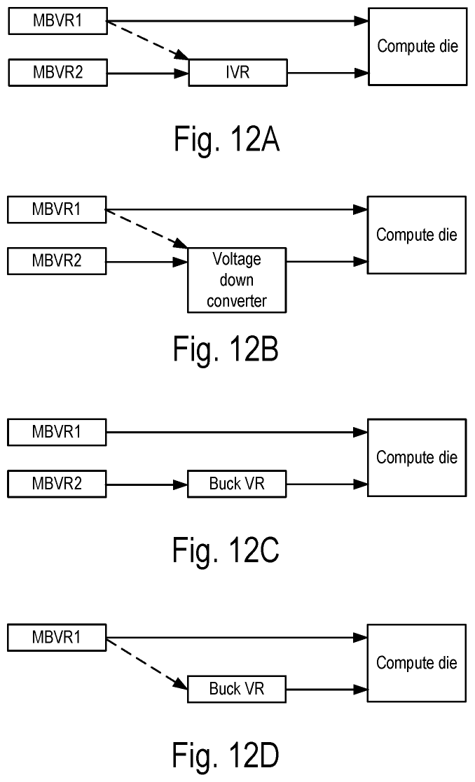

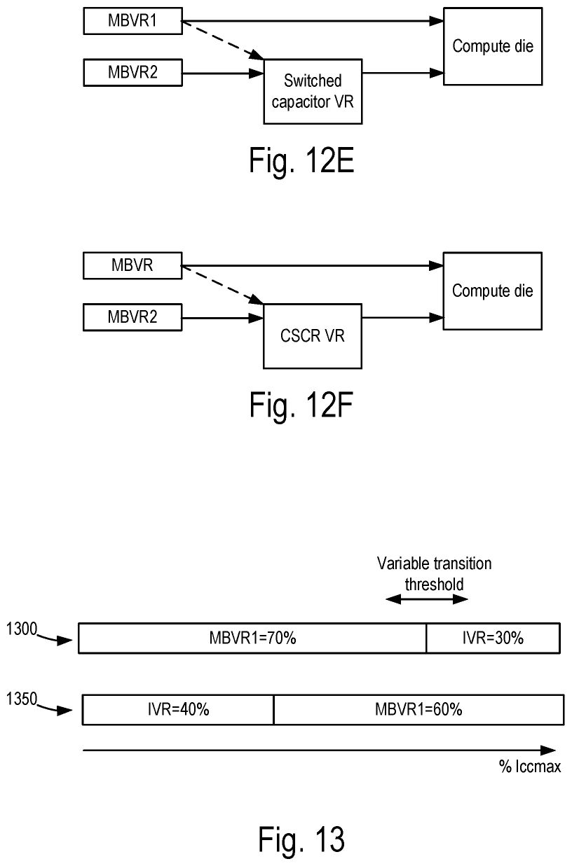

Generally, by detecting the output voltage at the node 630 via a feedback path 631 and comparing that with a provided reference voltage, the controller is able to monitor a current consumption of the load. The controller is capable of generating switching pulses as the voltage signals Vpg and Vng with a predefined frequency such that the current through the inductor balances out the current demanded by the load module while keeping the output voltage at the requested reference level. Any perturbation can be sensed by the deviation of the output voltage, and the IVR controller can increase or decrease the duty cycle of the pulses to minimize the deviation. The figure shows an example implementation of the IVR, but any form of down conversion can be used. See also FIGS. 12A-12F. 14 and 15.

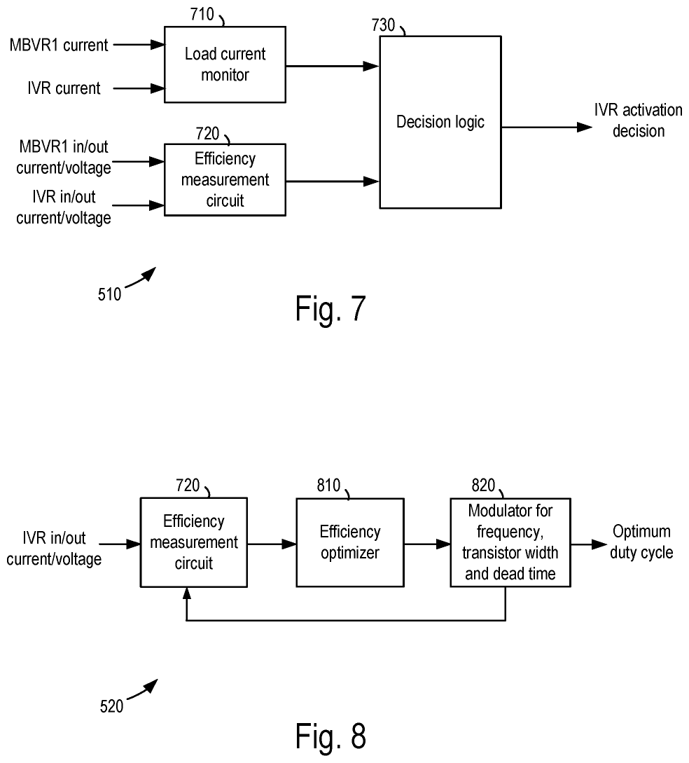

FIG. 7 depicts example circuit blocks of the parallel IVR operation controller 510 of FIG. 5, in accordance with various embodiments. The circuit blocks activate or deactivate the parallel operation. The load currents from both MBVR1 and the IVR are fed to the load current monitor 710, which decides when to turn on the parallel operation. Separately, the decision can also be made through the efficiency measurement circuit 720. For example, a predefined efficiency threshold can be set as a target activation point. Once the efficiency falls below the threshold, the decision logic 730 can activate the parallel IVR operation. The efficiency can be measured based on inputs such as the input and output current/voltage of MBVR1 as well as the input and output current/voltage of the IVR.

FIG. 8 depicts example circuit blocks of the IVR efficiency optimizer 520 of FIG. 5, in accordance with various embodiments. The circuit blocks include the efficiency measurement circuit 720, an efficiency optimizer 810 and a modulator for frequency, width and dead time 820. When the parallel IVR operation is activated, the IVR efficiency optimizer calculates, cycle by cycle, efficiency across the IVR, and then modulates the frequency of operation, width of the power transistor and/or the dead time value of the power transistor in order to find the maximum efficiency of operation. The frequency can be the frequency of Vpg and Vng in FIG. 6, for example. The transistor width can refer to the width of the transistors 605 and 606 in FIG. 6. In one example implementation, a number of individually-controllable transistors are provided which have different widths. For example, multiple versions of the transistor 605 with different widths can be provided. A digital code/control signal can be provided on a bus to select one of the transistors by controlling source-side, drain-side and/or control gate switches. The selected transistor 605 is then coupled to the inverter pairs 610, node 601 and the transistor 606. Multiple versions of the transistor 606 with different widths can similarly be provided. A digital code/control signal can be provided on a bus to select one of the transistors by controlling source-side, drain-side and/or control gate switches. The selected transistor 606 is then coupled to the inverter pairs 620, ground node and the transistor 605. The dead time refers to a small amount of time between the switching edges of a PWM signal such as Vpg and Vng.

These parameters can be swept independently with small increments at one time. Then, the efficiency can be re-measured to find out if the adjustment resulted in an improvement in the efficiency. The circuit can follow the positive gradient of efficiency as it modulates the parameters. For example, see the efficiency plot of FIG. 4. Through a sequential search, the circuit can find values of a set of parameters for which the efficiency is maximized and continue operating with those values. A further search to optimize the efficiency can be triggered when there is a substantial change in the load current (e.g., >10% change in load current).

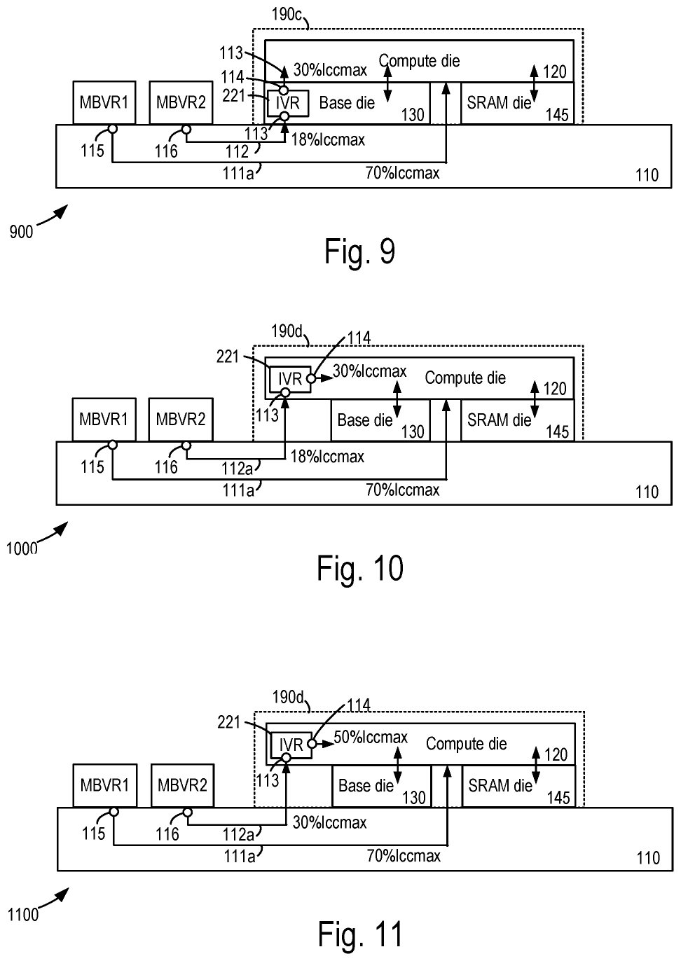

FIG. 9 depicts a cross-sectional view of an example stacked structure 900 corresponding to the stacked structure of FIG. 2 except that the IVR 221 is incorporated into the base die 130, in accordance with various embodiments. The location of the IVR can be based on requirements relating to application, design, fabrication concerns, cost and other factors. In some cases, the location is based on requirements of a system-on-a-chip (SoC). The stacked structure 900 incorporates the IVR 221 in the base die 130 within a package 190c. This approach can improve efficiency compared to providing the IVR in a separate die/chiplet. As in FIG. 2, the first current provided by MBVR1 is 70% Iccmax, the second current provided by MBVR2 is 18% Iccmax and the output current of the IVR is 30% Iccmax.

The base die may or may not be at the same technology node as the compute dic. In some case, the compute die is at a more advanced technology node as it may include a processor which is at the heart of the computing device.

FIG. 10 depicts a cross-sectional view of an example stacked structure 1000 corresponding to the stacked structure of FIG. 2 except that the IVR 221 is incorporated into the compute die 120, in accordance with various embodiments. This approach incorporates the IVR 221 in the compute die 120 within a package 190d. This approach can also improve efficiency compared to providing the IVR in a separate die/chiplet. As in FIG. 2, the first current provided by MBVR1 is 70% Iccmax, the second current provided by MBVR2 is 18% Iccmax and the output current of the IVR is 30% Iccmax.

FIG. 11 depicts a cross-sectional view of an example stacked structure 1100 corresponding to the stacked structure of FIG. 10 except that the compute die is driven at 120% of Iccmax, in accordance with various embodiments. In this example, the first current provided by MBVR1 is 70% Iccmax, as before, but the second current provided by MBVR2 is 30% Iccmax and the output current of the IVR is 50% Iccmax. As a result, the compute die receives 120% of Iccmax.

The IVR is fabricated with the same die as the load (e.g., the compute die) with iso-input package current. Since the IVR is receiving 30% current at its input node 113, the output current capacity of the IVR is now increased to about 50% of the original Iccmax. Hence, the compute die can now operate with an approximately 20% higher current than the baseline maximum current for temporary periods as needed. The load current capacity is thereby increased. This is advantageous as it allows a processor on the compute die to run approximately 20% faster, e.g., due to over clocking. The over clocking is typically limited in duration due to thermal concerns. A tradeoff is that the current in the conductive path 112a increases but this may be acceptable to achieve the higher current when needed.

The current values discussed are examples only, as other values may be used.

The solutions described are subject to a variety of extensions and generalities. For example, the solutions can be applied to any form of voltage down converter with or without the additional MBVR (MBVR2). A number of examples are provided in FIGS. 12A-12F. Examples of voltage down converters include inductive (FIGS. 12C and 12D), capacitive (FIGS. 12E and 12F) or any other form. The IVR may be fed by the same MBVR (FIG. 12D), by the second MBVR (MBVR2) (FIG. 12C), or by both MBVR1 and MBVR2 (FIGS. 12A, 12B, 12E and 12F).

FIG. 12A depicts an example power supply configuration in which MBVR1 provides current directly to a compute die, and optionally indirectly through an IVR, and MBVR2 provides current to the compute die through the IVR, in accordance with various embodiments.

FIG. 12B depicts an example power supply configuration in which MBVR1 provides current directly to a compute die, and optionally indirectly through any form of voltage down converter, and MBVR2 provides current to the compute die through the voltage down converter, in accordance with various embodiments.

FIG. 12C depicts an example power supply configuration in which MBVR1 provides current directly to a compute die, and MBVR2 provides current to the compute die through a buck VR, in accordance with various embodiments.

FIG. 12D depicts an example power supply configuration in which MBVR1 provides current directly to a compute die, and optionally indirectly through a buck VR, and MBVR2 is not used, in accordance with various embodiments.

FIG. 12E depicts an example power supply configuration in which MBVR1 provides current directly to a compute die, and optionally indirectly through a switched capacitor VR, and MBVR2 provides current to the compute die through the switched capacitor VR, in accordance with various embodiments.

FIG. 12F depicts an example power supply configuration in which MBVR1 provides current directly to a compute die, and optionally indirectly through a Continuously Scalable Conversion Ratio (CSCR) VR, and MBVR2 provides current to the compute die through the CSCR VR, in accordance with various embodiments.

FIG. 13 depicts example bar charts 1300 and 1350 showing first and second portions of a current consumption to be provided by MBVR1 and the IVR, in associated with the second VR, MBVR2, in accordance with various embodiments. The percentages depicted refer to Iccmax and the compute die current consumption. Generally, the current share between MBVR1 and the IVR can be fixed or variable. In one example, as discussed, 70% of Iccmax is provided by MBVR1 and 30% of Iccmax is provided by the IVR, when the compute die requires 100% of Iccmax. In this case, the first portion of the current consumption (a first current) is provided by MBVR1 and a second portion of the current consumption (a second current) is provided by IVR. See the bar chart 1300. Additionally, the specific portion of the load current to be shared between MBVR1 and the IVR can also be adjusted by a programmable threshold for activating the MBVR2 and IVR.

In another option, it can be useful for the IVR to provide the initial or early portion of the load current until the required load current exceeds a threshold level such as 40% Iccmax. See the bar chart 1350. At this point, MBVR1 is activated to begin outputting its current to provide up to 60% of Iccmax, for instance. For example, if the required load current is 60% of Iccmax, the IVR can provide 40% of Iccmax and MBVR1 can provide 20% of Iccmax. The threshold for activating MBVR1 may be less than 50%, in one approach. This approach is particularly suitable when the average current used by the load is relatively small, such as less than 50% Iccmax, since the IVR is more efficient than the MBVR1 at lower currents. The current usage tends to be relatively low for a user of a personal computing device and relatively high for a commercial server, for example.

Generally, MBVR1 and IVR (in combination with MBVR2) can operate in parallel in separate power delivery paths depending on a load current threshold. In the bar chart 1300, the IVR is turned on once the load current goes above 70% or other threshold. Until that point, MBVR1 alone supplies the load current. The turn-on threshold for the IVR can be software adjustable.

In the bar chart 1350, the IVR is turned on for the first portion of the load current and MBVR1 is turned on for the later portion. This means, when the load starts increasing, the IVR is the first one to turn on and supplies current up to 40% (or any other threshold) of Iccmax and, after that, MBVR1 is turned on and supplies the remaining current demand.

The generality of the solution is that the threshold value to turn on the parallel path is adjustable.

The generality of the solution is that the sequence of turning on the VRs is adjustable. For example, MBVR1 can turn on first, supplying current up to the threshold point and IVR can turn on later to supply the excess current above the threshold, or vice versa.

The MBVR which provides the majority of the current can be referred to as a primary VR and the additional MBVR can be referred to as a secondary or auxiliary VR.

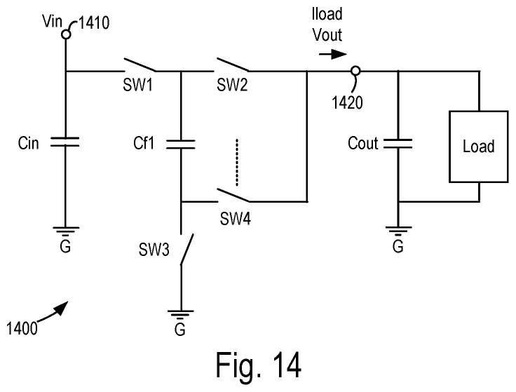

FIG. 14 depicts a switched-capacitor VR 1400 as an example implementation of the IVR, MBVR1 and/or MBVR2, in accordance with various embodiments. This example VR is configured as a single-stage charge pump with a single flying capacitor. A charge pump generally refers to a switching voltage converter that employs an intermediate capacitive storage element which is sometimes referred to as a flying capacitor or a charge transfer capacitor. One or more flying capacitors can be used. The charge pump is configured to provide Vout<Vin, in this example.

An input node 1410 receives an input voltage Vin. For example, Vin may be a fixed power supply voltage sometimes referred to as Vdd in a semiconductor chip. Charge from the voltage is maintained in an input capacitor Cin which is connected to a ground node G.

A set of switches SW1-SW4 are controlled by a control circuit CC to transfer charge from the input node to Cf, and from Cf to an output node 1420. The dotted lines depict control signal paths from the control circuit to the switches. Vout is a resulting voltage at the output node and Iload is a current drawn by the load (e.g., compute die). The output node is coupled to an output capacitor Cout, which is connected in series to a ground node G, and in parallel to the load. The switches may be MOSFETs, BJTs, or relay switches, for example. SW1 connects the top conductor of Cf to the input node 1410 to receive a charge from Vin. SW2 then connects the top conductor of Cf to the output node 1420 to transfer its charge to the output node. SW4 connects the bottom conductor of Cf to the output node 1420 to transfer its charge to the output node. SW3 connects the bottom conductor of Cf to a ground node.

A control circuit provides the switches with appropriate control signals to provide Vout at a desired level. The control circuit can include a sensor which monitors Vout at the output node via a feedback path. The control circuit can adjust the on/off times of the switches to regulate Vout at a target level.

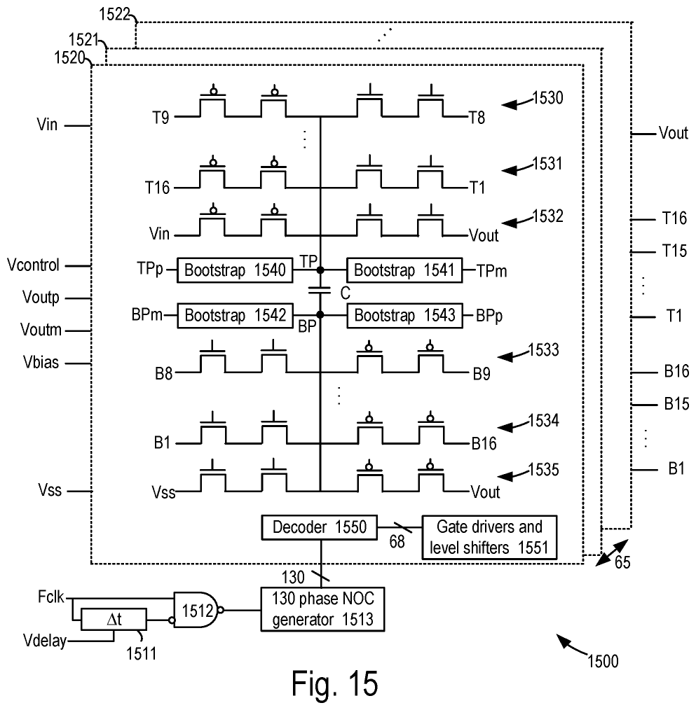

FIG. 15 depicts a CSCR VR 1500 as an example implementation of the IVR. MBVR1 and/or MBVR2, in accordance with various embodiments. A CSCR capacitive regulator uses multiphase soft charging of a capacitor C to provide a continuously scalable conversion-ratio with high efficiency. The basic idea is to maximize the voltage variation of the flying capacitor(s) by making it swing between approximately Vin and 0 V and back, regardless of the output voltage. Opening up the capacitors' voltages to have no fixed bias voltage dramatically increases the number of topologies, especially when also using many phases. To minimize the design complexity, a single-capacitor topology is depicted. For simplicity, it is assumed that the capacitor polarity stays the same over a full cycle.

The regulator includes a number (e.g., 65) of phase-shifted cores 1520, 1521, . . . , 1522. Each core includes sets of transistors 1530 . . . 1531 and 1532 associated with top side nodes T1 to T16, and sets of transistors 1533 . . . 1534 and 1535 associated with bottom side nodes B1 to B16. The are M soft-charging phases at the top side (nodes T1 to TM) and N soft-charging phases at the bottom side, with corresponding nodes B1-BN. The example topology is implemented with N, M=32. To enable direct charge transfers between capacitors through the soft-charging nodes, the converter is split into 1+N+M=65 phase-shifted cores. Due to out-phasing, only 16 top and bottom nodes have to be implemented.

All switches are implemented using two stacked thin-oxide transistors to enable a wide Vout range with a Vin of 2 V. Furthermore, to maximize their conductance over the entire range, four 3-pF bootstrap capacitors 1540, 1541, 1542 and 1543 are used per core, each of which generates a voltage rail relative to the top/bottom plate, T Pp/T Pm, and B Pp/B Pm, that is charged each time this plate connects to Vout using the external Voutp and Voutm rails. These external voltage rails are at a fixed voltage of 1 and −0.85 V relative to Vout. All transistors that connect to a soft-charging node need to block both positive and negative voltages across their drain-source and are, therefore, driven by tristate buffers. An external frequency reference, Folk, is divided using a non-overlapping clock generator 1513 into 130 phases, which are then distributed to each core's local decoder, such as the decoder 1550 of the core 1520. Folk is input to an AND gate 1512 and a variable delay circuit 1511, where the delay is set by Vdelay. The output of the decoder is provided to a gate drivers and level shifters circuit 1551.

The Vss connecting transistors together with the clock generator and other logic are powered by Vcontrol=1.1 V. Vcontrol, Voutp, and Voutm are provided externally for flexibility and measurement purposes, but their peak current consumptions allow them to be generated with classical charge pumps and limited overhead on the chip.

Thus, instead of a current multiplier at the output of the input-inductor converter, a linear or capacitive regulator can be added at the output, such as a Continuously Scalable Conversion Ratio (CSCR) capacitive regulator or a digital or analog linear regulator. In such an implementation, the upstream input-inductor converter can act as a fixed ratio converter without regulation, with the task of voltage regulation pushed to the downstream stage. Having a fully on-chip integrable capacitive or linear downstream stage also affords the advantage of combining multiple small rails to be fed by a single upstream stage, with each rail having its own dedicated downstream regulator that can all be capacitive, linear or a combination of both.

In one approach, the CSCR capacitive regulator is cascaded with, and downstream of, the active circuitry of the voltage converter, wherein the CSCR capacitive regulator is in at least one of the first die or a second die stacked on the first die.

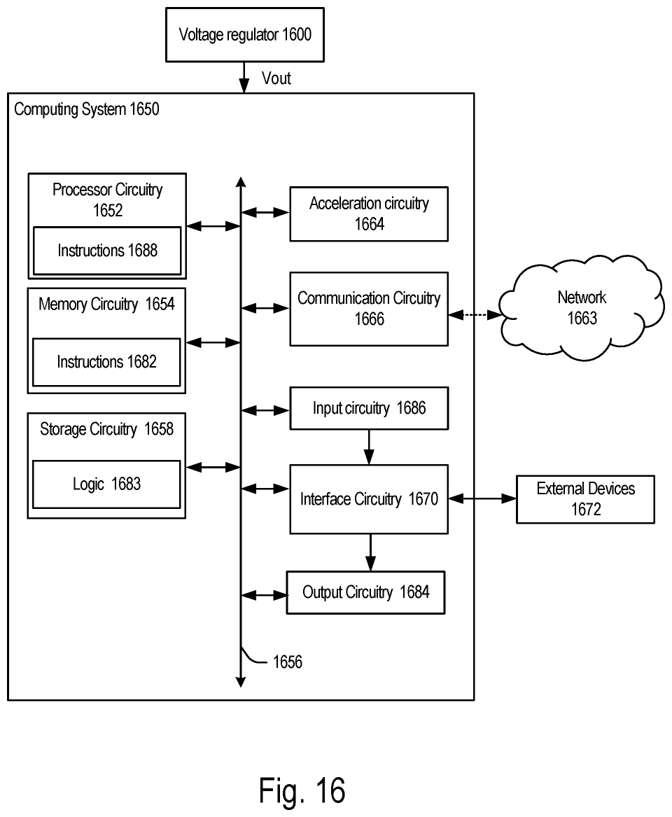

FIG. 16 illustrates an example of components that may be present in a computing system 1650 for implementing the techniques (e.g., operations, processes, methods, and methodologies) described herein. The voltage regulator 1600 may provide a voltage Vout to one or more of the components of the computing system 1650. The VR may be controlled by control signals provided by the processor circuitry 1652. The VR may include any of the VRs discussed herein including the IVR, MBVR1 and MBVR2.

The memory circuitry 1654 may store instructions and the processor circuitry 1652 may execute the instructions to perform the functions described herein.

The computing system 1650 may include any combinations of the hardware or logical components referenced herein. The components may be implemented as ICs, portions thereof, discrete electronic devices, or other modules, instruction sets, programmable logic or algorithms, hardware, hardware accelerators, software, firmware, or a combination thereof adapted in the computing system 1650, or as components otherwise incorporated within a chassis of a larger system. For one embodiment, at least one processor 1652 may be packaged together with computational logic 1682 and configured to practice aspects of various example embodiments described herein to form a System in Package (SiP) or a System on Chip (SoC).

The system 1650 includes processor circuitry in the form of one or more processors 1652. The processor circuitry 1652 includes circuitry such as, but not limited to one or more processor cores and one or more of cache memory, low drop-out voltage regulators (LDOs), interrupt controllers, serial interfaces such as SPI, I2C or universal programmable serial interface circuit, real time clock (RTC), timer-counters including interval and watchdog timers, general purpose I/O, memory card controllers such as secure digital/multi-media card (SD/MMC) or similar, interfaces, mobile industry processor interface (MIPI) interfaces and Joint Test Access Group (JTAG) test access ports. In some implementations, the processor circuitry 1652 may include one or more hardware accelerators (e.g., same or similar to acceleration circuitry 1664), which may be microprocessors, programmable processing devices (e.g., FPGA, ASIC, etc.), or the like. The one or more accelerators may include, for example, computer vision and/or deep learning accelerators. In some implementations, the processor circuitry 1652 may include on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

The processor circuitry 1652 may include, for example, one or more processor cores (CPUs), application processors, GPUs, RISC processors, Acorn RISC Machine (ARM) processors, CISC processors, one or more DSPs, one or more FPGAs, one or more PLDs, one or more ASICs, one or more baseband processors, one or more radio-frequency integrated circuits (RFIC), one or more microprocessors or controllers, a multi-core processor, a multithreaded processor, an ultra-low-voltage processor, an embedded processor, or any other known processing elements, or any suitable combination thereof. The processors (or cores) 1652 may be coupled with or may include memory/storage and may be configured to execute instructions stored in the memory/storage to enable various applications or operating systems to run on the platform 1650. The processors (or cores) 1652 is configured to operate application software to provide a specific service to a user of the platform 1650. In some embodiments, the processor(s) 1652 may be a special-purpose processor(s)/controller(s) configured (or configurable) to operate according to the various embodiments herein.

As examples, the processor(s) 1652 may include an Intel® Architecture Core™ based processor such as an i3, an i5, an i7, an i9 based processor; an Intel® microcontroller-based processor such as a Quark™, an Atom™, or other MCU-based processor; Pentium® processor(s), Xeon® processor(s), or another such processor available from Intel® Corporation, Santa Clara, California. However, any number other processors may be used, such as one or more of Advanced Micro Devices (AMD) Zen® Architecture such as Ryzen® or EPYC® processor(s), Accelerated Processing Units (APUs), MxGPUs, Epyc® processor(s), or the like; A5-A12 and/or S1-S4 processor(s) from Apple® Inc., Snapdragon™ or Centriq™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; the ThunderX2® provided by Cavium™, Inc.; or the like. In some implementations, the processor(s) 1652 may be a part of a system on a chip (SoC), System-in-Package (SiP), a multi-chip package (MCP), and/or the like, in which the processor(s) 1652 and other components are formed into a single integrated circuit, or a single package, such as the Edison™ or Galileo™ SoC boards from Intel® Corporation. Other examples of the processor(s) 1652 are mentioned elsewhere in the present disclosure.

The system 1650 may include or be coupled to acceleration circuitry 1664, which may be embodied by one or more AI/ML accelerators, a neural compute stick, neuromorphic hardware, an FPGA, an arrangement of GPUs, one or more SoCs (including programmable SoCs), one or more CPUs, one or more digital signal processors, dedicated ASICs (including programmable ASICs), PLDs such as complex (CPLDs) or high complexity PLDs (HCPLDs), and/or other forms of specialized processors or circuitry designed to accomplish one or more specialized tasks. These tasks may include AI/ML processing (e.g., including training, inferencing, and classification operations), visual data processing, network data processing, object detection, rule analysis, or the like. In FPGA-based implementations, the acceleration circuitry 1664 may comprise logic blocks or logic fabric and other interconnected resources that may be programmed (configured) to perform various functions, such as the procedures, methods, functions, etc. of the various embodiments discussed herein. In such implementations, the acceleration circuitry 1664 may also include memory cells (e.g., EPROM, EEPROM, flash memory, static memory (e.g., SRAM, anti-fuses, etc.) used to store logic blocks, logic fabric, data, etc. in LUTs and the like.

In some implementations, the processor circuitry 1652 and/or acceleration circuitry 1664 may include hardware elements specifically tailored for machine learning and/or artificial intelligence (AI) functionality. In these implementations, the processor circuitry 1652 and/or acceleration circuitry 1664 may be, or may include, an AI engine chip that can run many different kinds of AI instruction sets once loaded with the appropriate weightings and training code. Additionally or alternatively, the processor circuitry 1652 and/or acceleration circuitry 1664 may be, or may include, AI accelerator(s), which may be one or more of the aforementioned hardware accelerators designed for hardware acceleration of AI applications. As examples, these processor(s) or accelerators may be a cluster of artificial intelligence (AI) GPUs, tensor processing units (TPUs) developed by Google® Inc., Real AI Processors (RAPS™) provided by AlphaICs®, Nervana™ Neural Network Processors (NNPs) provided by Intel® Corp., Intel® Movidius™ Myriad™ X Vision Processing Unit (VPU), NVIDIA® PX™ based GPUs, the NM500 chip provided by General Vision®, Hardware 3 provided by Tesla®, Inc., an Epiphany™ based processor provided by Adapteva®, or the like. In some embodiments, the processor circuitry 1652 and/or acceleration circuitry 1664 and/or hardware accelerator circuitry may be implemented as AI accelerating co-processor(s), such as the Hexagon 685 DSP provided by Qualcomm®, the PowerVR 2NX Neural Net Accelerator (NNA) provided by Imagination Technologies Limited®, the Neural Engine core within the Apple® A11 or A12 Bionic SoC, the Neural Processing Unit (NPU) within the HiSilicon Kirin 1670 provided by Huawei®, and/or the like. In some hardware-based implementations, individual subsystems of system 1650 may be operated by the respective AI accelerating co-processor(s), AI GPUs, TPUs, or hardware accelerators (e.g., FPGAs, ASICs, DSPs, SoCs, etc.), etc., that are configured with appropriate logic blocks, bit stream(s), etc. to perform their respective functions.

The system 1650 also includes system memory 1654. Any number of memory devices may be used to provide for a given amount of system memory. As examples, the memory 1654 may be, or includes, volatile memory such as random access memory (RAM), static RAM (SRAM), dynamic RAM (DRAM), synchronous DRAM (SDRAM), RAMBUS® Dynamic Random Access Memory (RDRAM®), and/or any other desired type of volatile memory device. Additionally or alternatively, the memory 1654 may be, or include, non-volatile memory such as read-only memory (ROM), erasable programmable ROM (EPROM), electrically erasable programmable (EEPROM), flash memory, non-volatile RAM, ferroelectric RAM, phase-change memory (PCM), flash memory, and/or any other desired type of non-volatile memory device. Access to the memory 1654 is controlled by a memory controller. The individual memory devices may be of any number of different package types such as single die package (SDP), dual dic package (DDP) or quad die package (Q17P). Any number of other memory implementations may be used, such as dual inline memory modules (DIMMs) of different varieties including but not limited to microDIMMs or MiniDIMMs.

Storage circuitry 1658 provides persistent storage of information such as data, applications, operating systems and so forth. In an example, the storage 1658 may be implemented via a solid-state disk drive (SSDD) and/or high-speed electrically erasable memory (commonly referred to as “flash memory”). Other devices that may be used for the storage 1658 include flash memory cards, such as SD cards, microSD cards, XD picture cards, and the like, and USB flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, phase change RAM (PRAM), resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a Domain Wall (DW) and Spin Orbit Transfer (SOT) based device, a thyristor based memory device, a hard disk drive (HDD), micro HDD, of a combination thereof, and/or any other memory. The memory circuitry 1654 and/or storage circuitry 1658 may also incorporate three-dimensional (3D) cross-point (XPOINT) memories from Intel® and Micron®.

The memory circuitry 1654 and/or storage circuitry 1658 is/are configured to store computational logic 1683 in the form of software, firmware, microcode, or hardware-level instructions to implement the techniques described herein. The computational logic 1683 may be employed to store working copies and/or permanent copies of programming instructions, or data to create the programming instructions, for the operation of various components of system 1650 (e.g., drivers, libraries, application programming interfaces (APIs), etc.), an operating system of system 1650, one or more applications, and/or for carrying out the embodiments discussed herein. The computational logic 1683 may be stored or loaded into memory circuitry 1654 as instructions 1682, or data to create the instructions 1682, which are then accessed for execution by the processor circuitry 1652 to carry out the functions described herein. The processor circuitry 1652 and/or the acceleration circuitry 1664 accesses the memory circuitry 1654 and/or the storage circuitry 1658 over the interconnect (IX) 1656. The instructions 1682 direct the processor circuitry 1652 to perform a specific sequence or flow of actions, for example, as described with respect to flowchart(s) and block diagram(s) of operations and functionality depicted previously. The various elements may be implemented by assembler instructions supported by processor circuitry 1652 or high-level languages that may be compiled into instructions 1688, or data to create the instructions 1688, to be executed by the processor circuitry 1652. The permanent copy of the programming instructions may be placed into persistent storage devices of storage circuitry 1658 in the factory or in the field through, for example, a distribution medium (not shown), through a communication interface (e.g., from a distribution server (not shown)), over-the-air (OTA), or any combination thereof.

The IX 1656 couples the processor 1652 to communication circuitry 1666 for communications with other devices, such as a remote server (not shown) and the like. The communication circuitry 1666 is a hardware element, or collection of hardware elements, used to communicate over one or more networks 1663 and/or with other devices. In one example, communication circuitry 1666 is, or includes, transceiver circuitry configured to enable wireless communications using any number of frequencies and protocols such as, for example, the Institute of Electrical and Electronics Engineers (IEEE) 802.11 (and/or variants thereof), IEEE 802.23.4, Bluetooth® and/or Bluetooth® low energy (BLE), ZigBee®, LoRaWAN™ (Long Range Wide Area Network), a cellular protocol such as 3GPP LTE and/or Fifth Generation (5G)/New Radio (NR), and/or the like. Additionally or alternatively, communication circuitry 1666 is, or includes, one or more network interface controllers (NICs) to enable wired communication using, for example, an Ethernet connection, Controller Area Network (CAN), Local Interconnect Network (LIN), DeviceNet, ControlNet, Data Highway+, or PROFINET, among many others.

The IX 1656 also couples the processor 1652 to interface circuitry 1670 that is used to connect system 1650 with one or more external devices 1672. The external devices 1672 may include, for example, sensors, actuators, positioning circuitry (e.g., global navigation satellite system (GNSS)/Global Positioning System (GPS) circuitry), client devices, servers, network appliances (e.g., switches, hubs, routers, etc.), integrated photonics devices (e.g., optical neural network (ONN) integrated circuit (IC) and/or the like), and/or other like devices.

In some optional examples, various input/output (I/O) devices may be present within or connected to, the system 1650, which are referred to as input circuitry 1686 and output circuitry 1684. The input circuitry 1686 and output circuitry 1684 include one or more user interfaces designed to enable user interaction with the platform 1650 and/or peripheral component interfaces designed to enable peripheral component interaction with the platform 1650. Input circuitry 1686 may include any physical or virtual means for accepting an input including, inter alia, one or more physical or virtual buttons (e.g., a reset button), a physical keyboard, keypad, mouse, touchpad, touchscreen, microphones, scanner, headset, and/or the like. The output circuitry 1684 may be included to show information or otherwise convey information, such as sensor readings, actuator position(s), or other like information. Data and/or graphics may be displayed on one or more user interface components of the output circuitry 1684. Output circuitry 1684 may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Crystal Displays (LCD), LED displays, quantum dot displays, projectors, etc.), with the output of characters, graphics, multimedia objects, and the like being generated or produced from the operation of the platform 1650. The output circuitry 1684 may also include speakers and/or other audio emitting devices, printer(s), and/or the like. Additionally or alternatively, sensor(s) may be used as the input circuitry 1684 (e.g., an image capture device, motion capture device, or the like) and one or more actuators may be used as the output device circuitry 1684 (e.g., an actuator to provide haptic feedback or the like). Peripheral component interfaces may include, but are not limited to, a non-volatile memory port, a USB port, an audio jack, a power supply interface, etc. In some embodiments, a display or console hardware, in the context of the present system, may be used to provide output and receive input of an edge computing system; to manage components or services of an edge computing system; identify a state of an edge computing component or service; or to conduct any other number of management or administration functions or service use cases.

The components of the system 1650 may communicate over the IX 1656. The IX 1656 may include any number of technologies, including ISA, extended ISA, I2C, SPI, point-to-point interfaces, power management bus (PMBus), PCI, PCIe, PCIx, Intel® UPI, Intel® Accelerator Link, Intel® CXL, CAPI, OpenCAPI, Intel® QPI, UPI, Intel® OPA IX, RapidIO™ system IXs, CCIX, Gen-Z Consortium IXs, a HyperTransport interconnect, NVLink provided by NVIDIA®, a Time-Trigger Protocol (TTP) system, a FlexRay system, PROFIBUS, and/or any number of other IX technologies. The IX 1656 may be a proprietary bus, for example, used in a SoC based system.

The number, capability, and/or capacity of the elements of system 1650 may vary, depending on whether computing system 1650 is used as a stationary computing device (e.g., a server computer in a data center, a workstation, a desktop computer, etc.) or a mobile computing device (e.g., a smartphone, tablet computing device, laptop computer, game console, IoT device, etc.). In various implementations, the computing device system 1650 may comprise one or more components of a data center, a desktop computer, a workstation, a laptop, a smartphone, a tablet, a digital camera, a smart appliance, a smart home hub, a network appliance, and/or any other device/system that processes data.

The techniques described herein can be performed partially or wholly by software or other instructions provided in a machine-readable storage medium (e.g., memory). The software is stored as processor-executable instructions (e.g., instructions to implement any other processes discussed herein). Instructions associated with the flowchart (and/or various embodiments) and executed to implement embodiments of the disclosed subject matter may be implemented as part of an operating system or a specific application, component, program, object, module, routine, or other sequence of instructions or organization of sequences of instructions.

The storage medium can be a tangible, non-transitory machine readable medium such as read only memory (ROM), random access memory (RAM), flash memory devices, floppy and other removable disks, magnetic storage media, optical storage media (e.g., Compact Disk Read-Only Memory (CD ROMS), Digital Versatile Disks (DVDs)), among others.

The storage medium may be included, e.g., in a communication device, a computing device, a network device, a personal digital assistant, a manufacturing tool, a mobile communication device, a cellular phone, a notebook computer, a tablet, a game console, a set top box, an embedded system, a TV (television), or a personal desktop computer.

Some non-limiting examples of various embodiments are presented below.

Example 1 includes an apparatus, comprising: a package base layer; a package on the package base layer, wherein the package comprises a compute die; a first voltage regulator (VR) external to the package, wherein the first VR is coupled to the package; and a second VR external to the package, wherein the second VR is coupled to the package and is capable of providing a second current to the compute die to augment a first current provided to the compute die by the first VR.

Example 2 includes the apparatus of Example 1, further comprising a control circuit to monitor a current consumption of the compute die, wherein the control circuit is to activate the first VR and not the second VR when the current consumption does not exceed a threshold, and to activate the second VR while continuing to activate the first VR when the current consumption exceeds the threshold.

Example 3 includes the apparatus of Example 2, wherein the first current is capped at the threshold when the current consumption exceeds the threshold.

Example 4 includes the apparatus of any one of Examples 1-3, further comprising an integrated voltage regulator (IVR) in the package, wherein the IVR has an input coupled to the second VR and an output coupled to the compute die, and the IVR is capable of providing voltage down conversion and current multiplication.

Example 5 includes the apparatus of Example 4, wherein the first VR is to provide the first current to the compute die without the first current undergoing current multiplication.

Example 6 includes the apparatus of Example 4 or 5, wherein the IVR comprises a chiplet on the package base layer, and the chiplet is separate from the compute die.

Example 7 includes the apparatus of Example 4 or 5, wherein the IVR is part of the compute die or a base die of the package.

Example 8 includes the apparatus of any one of Examples 1-7, further comprising a control circuit to monitor a current consumption of the compute die, wherein the control circuit is to activate the first VR and not the second VR when the current consumption does not exceed a threshold, and to activate the second VR while continuing to activate the first VR when the current consumption exceeds the threshold.

Example 9 includes the apparatus of any one of Examples 1-8, further comprising a control circuit to monitor an efficiency of the first VR and to activate the second VR when the efficiency falls below a threshold.

Example 10 includes the apparatus of any one of Examples 1-9, further comprising a control circuit to monitor an efficiency of the second VR, and to adjust at least one of a frequency, a width of a power transistor or a dead time of the second VR, to optimize the efficiency of the second VR.

Example 11 includes the apparatus of any one of Examples 1-10, further comprising a computing device in which the package base layer, the package, the first VR and the second VR are provided.

Example 12 includes an apparatus, comprising: a first voltage regulators (VR) and a second VR on one or more motherboards; a package base layer on which the one or more motherboards are carried; first and second conductive paths in the package base layer, wherein the first and second conductive paths are coupled to a package on the package base layer; and a control circuit, wherein the control circuit is to monitor a current consumption associated with the package and, based on the monitoring, determine a first current and a second current to be provided by the first and second VRs, respectively.

Example 13 includes the apparatus of Example 12, wherein the control circuit is to activate the second VR when the current consumption exceeds a threshold.

Example 14 includes the apparatus of Example 13, wherein: the control circuit is to cap the first current at the threshold when the current consumption exceeds the threshold; and the second VR is to supply the second current based on a difference between the current consumption and the threshold.

Example 15 includes the apparatus of any one of Examples 12-14, wherein the control circuit is to monitor an efficiency of the first VR and to activate the second VR when the efficiency falls below a threshold.

Example 16 includes a semiconductor package, comprising: a package base layer; a load attached to the package base layer; and an integrated voltage regulator (IVR), wherein the load is coupled to a first voltage regulator (VR) and to an output of the IVR, and the IVR has an input coupled to a second VR.

Example 17 includes the semiconductor package of Example 16, wherein the IVR is capable of providing voltage down conversion and current multiplication of a current received from the second VR.

Example 18 includes the semiconductor package of Example 17, wherein the IVR is to receive a control signal to begin providing the voltage down conversion and the current multiplication of the current received from the second VR when a current consumption of the load exceeds a threshold.

Example 19 includes the semiconductor package of Example 18, wherein a current received from the first VR is capped at the threshold when the current consumption of the load exceeds the threshold.

Example 20 includes the semiconductor package of any one of Examples 17-19, wherein the IVR is to receive a control signal to begin providing the voltage down conversion and the current multiplication of the current received from the second VR when an efficiency of the first VR falls below a threshold.

Example 21 includes a method, comprising: providing a first current from a first voltage regulator (VR) to a compute die via a package base layer; determining that the first current has reached a threshold; and when the first current has reached the threshold, begin providing a second current from a second VR to a current multiplier via the package base layer, and providing a multiplied version of the second current from the current multiplier to the compute die.

Example 22 includes the method of Example 21, further comprising capping the first current at the threshold when the first current has reached the threshold.

Example 23 includes a non-transitory machine-readable storage including machine-readable instructions that, when executed, cause a processor or other circuit or computing device to implement the method of Example 21 or 22.

Example 24 includes a computer program comprising instructions which, when the program is executed by a computer, cause the computer to carry out the method of Example 21 or 22. Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

The terms “substantially,” “close,” “approximately,” “near,” and “about,” generally refer to being within +/−10% of a target value. Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

For the purposes of the present disclosure, the phrases “A and/or B” and “A or B” mean (A), (B), or (A and B). For the purposes of the present disclosure, the phrase “A, B, and/or C” means (A), (B), (C), (A and B), (A and C), (B and C), or (A, B, and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “circuitry” may refer to, be part of, or include an Application Specific Integrated Circuit (ASIC), an electronic circuit, a processor (shared, dedicated, or group), a combinational logic circuit, and/or other suitable hardware components that provide the described functionality. As used herein, “computer-implemented method” may refer to any method executed by one or more processors, a computer system having one or more processors, a mobile device such as a smartphone (which may include one or more processors), a tablet, a laptop computer, a set-top box, a gaming console, and so forth.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional elements.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

While the disclosure has been described in conjunction with specific embodiments thereof, many alternatives, modifications and variations of such embodiments will be apparent to those of ordinary skill in the art in light of the foregoing description. The embodiments of the disclosure are intended to embrace all such alternatives, modifications, and variations as to fall within the broad scope of the appended claims.

In addition, well-known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are highly dependent upon the platform within which the present disclosure is to be implemented (i.e., such specifics should be well within purview of one skilled in the art). Where specific details (e.g., circuits) are set forth in order to describe example embodiments of the disclosure, it should be apparent to one skilled in the art that the disclosure can be practiced without, or with variation of, these specific details. The description is thus to be regarded as illustrative instead of limiting.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

What is claimed is:

1. An apparatus, comprising:
a package base layer;
a package on the package base layer, wherein the package comprises a compute die;
a first voltage regulator (VR) external to the package, wherein the first VR is coupled to the package; and
a second VR external to the package, wherein the second VR is coupled to the package and is capable of providing a second current to the compute die to augment a first current provided to the compute die by the first VR.

2. The apparatus of claim 1, further comprising a control circuit to monitor a current consumption of the compute die, wherein the control circuit is to activate the first VR and not the second VR when the current consumption does not exceed a threshold, and to activate the second VR while continuing to activate the first VR when the current consumption exceeds the threshold.

3. The apparatus of claim 2, wherein the first current is capped at the threshold when the current consumption exceeds the threshold.

4. The apparatus of claim 1, further comprising an integrated voltage regulator (IVR) in the package, wherein the IVR has an input coupled to the second VR and an output coupled to the compute die, and the IVR is capable of providing voltage down conversion and current multiplication.

5. The apparatus of claim 4, wherein the first VR is to provide the first current to the compute die without the first current undergoing current multiplication.

6. The apparatus of claim 4, wherein the IVR comprises a chiplet on the package base layer, and the chiplet is separate from the compute die.

7. The apparatus of claim 4, wherein the IVR is part of the compute die or a base die of the package.

8. The apparatus of claim 1, further comprising a control circuit to monitor a current consumption of the compute die, wherein the control circuit is to activate the first VR and not the second VR when the current consumption does not exceed a threshold, and to activate the second VR while continuing to activate the first VR when the current consumption exceeds the threshold.

9. The apparatus of claim 1, further comprising a control circuit to monitor an efficiency of the first VR and to activate the second VR when the efficiency falls below a threshold.

10. The apparatus of claim 1, further comprising a control circuit to monitor an efficiency of the second VR, and to adjust at least one of a frequency, a width of a power transistor or a dead time of the second VR, to optimize the efficiency of the second VR.

11. The apparatus of claim 1, further comprising a computing device in which the package base layer, the package, the first VR and the second VR are provided.

12. An apparatus, comprising:
a first voltage regulators (VR) and a second VR on one or more motherboards;
a package base layer on which the one or more motherboards are carried;
first and second conductive paths in the package base layer, wherein the first and second conductive paths are coupled to a package on the package base layer; and
a control circuit, wherein the control circuit is to monitor a current consumption associated with the package and, based on the monitoring, determine a first current and a second current to be provided by the first and second VRs, respectively.

13. The apparatus of claim 12, wherein the control circuit is to activate the second VR when the current consumption exceeds a threshold.

14. The apparatus of claim 13, wherein:
the control circuit is to cap the first current at the threshold when the current consumption exceeds the threshold; and
the second VR is to supply the second current based on a difference between the current consumption and the threshold.

15. The apparatus of claim 12, wherein the control circuit is to monitor an efficiency of the first VR and to activate the second VR when the efficiency falls below a threshold.

16. A semiconductor package, comprising:
a package base layer;
a load attached to the package base layer; and
an integrated voltage regulator (IVR), wherein the load is coupled to a first voltage regulator (VR) and to an output of the IVR, and the IVR has an input coupled to a second VR.

17. The semiconductor package of claim 16, wherein the IVR is capable of providing voltage down conversion and current multiplication of a current received from the second VR.

18. The semiconductor package of claim 17, wherein the IVR is to receive a control signal to begin providing the voltage down conversion and the current multiplication of the current received from the second VR when a current consumption of the load exceeds a threshold.

19. The semiconductor package of claim 18, wherein a current received from the first VR is capped at the threshold when the current consumption of the load exceeds the threshold.

20. The semiconductor package of claim 17, wherein the IVR is to receive a control signal to begin providing the voltage down conversion and the current multiplication of the current received from the second VR when an efficiency of the first VR falls below a threshold.
